(19) United States
(12) Patent Application Publication
(10) Pub. No.: US 2013/0059948 A1
(43) Pub. Date: Mar. 7, 2013

(54) MOISTURE-CURABLE SEALING COMPOSITION AND SEALING COMPOSITION SHEET

(71) Applicant: Yasuhiko Kawaguchi, Osaka (JP)

(72) Inventor: Yasuhiko Kawaguchi, Osaka (JP)

(73) Assignee: NITTO DENKO CORPORATION, Osaka (JP)

(21) Appl. No.: 13/697,980

(22) PCT Filed: May 24, 2011
(86) PCT No.: PCT/JP2011/061808

§ 371 Date: Nov. 14, 2012

(30) Foreign Application Priority Data
May 26, 2010 (JP) 2010-120963
May 26, 2010 (JP) 2010-120966

(51) Int. Cl. C08L 33/20; C08K 3/26; C08K 3/20

(52) U.S. Cl. 524/5; 524/425

(57) ABSTRACT

A moisture-curable sealing composition contains a carboxyl group-containing polymer having a carboxyl group, a plasticizer, and a metal oxide-containing component containing a metal oxide and/or a metal carbonate.

### TECHNICAL FIELD

The present invention relates to a moisture-curable sealing composition used to fill a gap portion or the like and a sealing composition sheet formed from the moisture-curable sealing composition into a sheet shape.

### BACKGROUND ART

Conventionally, as a sealing composition used to fill a gap portion or the like, depending on an object to be sealed, a sealing composition such as a thermally-curable sealing composition, a moisture-curable sealing composition, or an ultraviolet-curable sealing composition has been known.

Of these, the moisture-curable sealing composition is usually in a liquid state at normal temperature and has been widely used to fill a gap portion where heating or application of ultraviolet rays cannot be performed. As such a moisture-curable sealing composition, for example, a moisture-curable silicone resin composition containing a silicone resin, a silane coupling agent, and a modified silicone resin has been proposed (ref: for example, the following Patent Document 1).

### PRIOR ART DOCUMENT

### Patent Document

Patent Document 1: Japanese Unexamined Patent Publication No. 2007-262140

### SUMMARY OF THE INVENTION

### Problems to be solved by the Invention

However, the silicone resin composition described in the above-described Patent Document 1 is prepared in a liquid state, so that the injected amount of the silicone resin composition with respect to a gap portion easily changes due to the fluidity thereof and therefore, the uniform filling is difficult.

In the silicone resin composition, a low-boiling component is generated at the time of curing, so that the operating environment is reduced.

On the other hand, in order to improve the above-described disadvantage, a putty-like sealing composition made of a rubber in which the viscosity is adjusted has been proposed.

However, there is a disadvantage that, in the putty-like sealing composition, the viscosity easily changes in accordance with the environmental temperature including a case where the viscosity excessively becomes high at low temperature, so that on filling a gap portion, the followability with respect to the gap portion is reduced or a case where the viscosity excessively becomes low at high temperature, so that after filling the gap portion, a sag or drip occurs and a space is generated.

It is an object of the present invention to provide a moisture-curable sealing composition capable of improving the followability with respect to a gap portion and uniformly filling the gap portion, and a sealing composition sheet formed from the moisture-curable sealing composition into a sheet shape.

### Solution to the Problems

In order to achieve the above-described object, a moisture-curable sealing composition of the present invention contains a carboxyl group-containing polymer having a carboxyl group, a plasticizer, and a metal oxide-containing component containing a metal oxide and/or a metal carbonate.

In the moisture-curable sealing composition of the present invention, it is preferable that the hardness thereof before curing is, in a Type C hardness test specified in JIS K 7312, 5 to 50 when measured after a pressurized surface of a Type C durometer is brought into close contact therewith for 10 seconds.

In the moisture-curable sealing composition of the present invention, it is preferable that the carboxyl group is contained in the carboxyl group-containing polymer at a content ratio of 0.1 to 10 mass %.

In the moisture-curable sealing composition of the present invention, it is preferable that the carboxyl group-containing polymer is obtained by polymerizing a monomer composition containing 55 to 95 mass % of an alkyl acrylate monomer, 4 to 40 mass % of a cyano group-containing vinyl monomer, and 0.1 to 10 mass % of a carboxyl group-containing vinyl monomer.

In the moisture-curable sealing composition of the present invention, it is preferable that the moisture-curable sealing composition further contains a tackifier.

In the moisture-curable sealing composition of the present invention, it is preferable that the plasticizer is contained at a content ratio of 10 to 300 parts by mass with respect to 100 parts by mass of the carboxyl group-containing polymer.

In the moisture-curable sealing composition of the present invention, it is preferable that the metal oxide-containing component and/or the metal carbonate are/is contained at a content ratio of 5 to 200 parts by mass with respect to 100 parts by mass of the carboxyl group-containing polymer.

In the moisture-curable sealing composition of the present invention, it is preferable that the metal oxide is an oxide of a Group 2 element.

In the moisture-curable sealing composition of the present invention, it is preferable that the metal carbonate is a calcium carbonate.

A sealing composition sheet of the present invention is formed from the above-described moisture-curable sealing composition into a sheet shape.

### Effect of the Invention

The moisture-curable sealing composition of the present invention is capable of improving the followability with respect to a gap portion and uniformly filling the gap portion.

### Embodiment of the Invention

A moisture-curable sealing composition of the present invention contains a carboxyl group-containing polymer having a carboxyl group, a plasticizer, and a metal oxide-containing component containing a metal oxide and/or a metal carbonate.

An example of the carboxyl group-containing polymer includes a polymer (a rubber or a resin) obtained by carboxyl-modifying an isoprene rubber, a butadiene rubber, an acrylonitrile-butadiene rubber, a styrene-butadiene rubber, a styrene-butadiene-styrene block polymer, a styrene-isoprene-styrene block polymer, or an acrylic polymer. Preferably, a carboxyl-modified acrylic polymer is used.

The carboxyl-modified acrylic polymer is obtained by polymerizing a monomer composition containing an alkyl(meth)acrylate monomer((meth)acrylate is defined as acrylate or meth acrylate, hereinafter the same) and a carboxyl group-containing vinyl monomer.

An example of the alkyl(meth)acrylate includes an alkyl(meth)acrylate containing a straight chain or branched chain alkyl group having 2 to 12 carbon atoms such as ethyl(meth)acrylate, propyl(meth)acrylate, isopropyl(meth)acrylate, butyl(meth)acrylate, isobutyl(meth)acrylate, sec-butyl(meth)acrylate, t-butyl(meth)acrylate, pentyl(meth)acrylate, neopentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, and lauryl(meth)acrylate. Preferably, an alkyl(meth)acrylate containing a straight chain or branched chain alkyl group having 2 to 4 carbon atoms such as ethyl(meth)acrylate, propyl(meth)acrylate, isopropyl(meth)acrylate, butyl(meth)acrylate, isobutyl(meth)acrylate, sec-butyl(meth)acrylate, and t-butyl(meth)acrylate is used.

When the alkyl(meth)acrylate monomer is used, the flexibility of the moisture-curable sealing composition before curing is ensured, so that the followability with respect to a gap portion can be improved and the shape retention of the sealing composition sheet can be improved.

Examples of the carboxyl group-containing vinyl monomer include an unsaturated carboxylic acid such as acrylic acid, methacrylic acid, fumaric acid, maleic acid, itaconic acid, crotonic acid, and cinnamic acid and an unsaturated dicarboxylic anhydride such as fumaric acid anhydride, maleic acid anhydride, and itaconic acid anhydride.

The monomer composition may contain a monomer which is copolymerizable with the above-described monomer. Examples of the monomer include a reactive functional group-containing vinyl monomer and a polyfunctional vinyl monomer. Preferably, a reactive functional group-containing vinyl monomer is used.

Examples of the reactive functional group-containing vinyl monomer include a cyano group-containing vinyl monomer such as (meth)acrylonitrile; a hydroxyl group-containing vinyl monomer such as 2-hydroxyethyl acrylate, 2-hydroxypropyl acrylate, and 4-hydroxybutyl acrylate; an epoxy group-containing vinyl monomer such as glycidyl(meth)acrylate, methylglycidyl(meth)acrylate, and glycerin di(meth)acrylate; an amino group-containing vinyl monomer such as aminoethyl(meth)acrylate and dimethylaminoethyl(meth)acrylate; an isocyanate group-containing vinyl monomer such as 2-methacryloyloxyethylisocyanate; an amide group-containing vinyl monomer such as (meth)acrylamide; and a maleimide-based imide group-containing vinyl monomer such as N-cyclohexylmaleimide and N-isopropylmaleimide. Preferably, a cyano group-containing vinyl monomer is used.

Examples of the polyfunctional vinyl monomer include (mono- or poly-) alkylene polyol poly(meth)acrylate such as ethyleneglycol di(meth)acrylate, diethyleneglycol di(meth)acrylate, triethyleneglycol di(meth)acrylate, trimethylolpropane tri(meth)acrylate, tetraethyleneglycol di(meth)acrylate, neopentylglycol di(meth)acrylate, 1,6-hexanediol di(meth)acrylate, pentaerythritol di(meth)acrylate, tetramethylolmethane tri(meth)acrylate, and dipentaerythritol hexa(meth)acrylate.

The monomer composition contains 90 to 99.9 mass %, or preferably 92 to 99.5 mass % of the alkyl acrylate monomer and 0.1 to 10 mass %, or preferably 0.5 to 8 mass % of the carboxyl group-containing vinyl monomer. When a copolymerizable monomer is contained in the monomer composition, the content ratio thereof is below 55 mass %.

When a cyano group-containing vinyl monomer, as a copolymerizable monomer, is contained in the monomer composition, the monomer composition contains 55 to 95 mass %, or preferably 60 to 90 mass % of the alkyl acrylate monomer; 0.1 to 10 mass %, or preferably 0.5 to 8 mass % of the carboxyl group-containing vinyl monomer; and 4 to 40 mass %, or preferably 8 to 35 mass % of the cyano group-containing vinyl monomer.

A known method may be used as the polymerization method of the acrylic polymer and, for example, suspension polymerization, bulk polymerization, or emulsion polymerization can be appropriately selected.

In the polymerization of the acrylic polymer, a known polymerization initiator, reaction solvent, chain transfer agent, emulsifier, or the like can be appropriately used. When a reaction solvent is used in the polymerization of the acrylic polymer, the reaction solvent is distilled off after the reaction by a method such as distillation.

The carboxyl group-containing polymer contains, for example, 0.1 to 10 mass %, or preferably 0.5 to 8 mass % of the carboxyl group.

When the content of the carboxyl group is below 0.1 mass %, the moisture- curable sealing composition may not be sufficiently cured. When the content of the carboxyl group exceeds 10 mass %, the carboxyl group-containing polymer may be excessively hardened at normal temperature (25° C.).

The plasticizer is not particularly limited as long as it is capable of plasticizing the carboxyl group-containing polymer. Examples of the plasticizer include a phthalate plasticizer and an aliphatic plasticizer.

An example of the phthalate plasticizer includes a phthalate such as dioctyl phthalate (DOP), dioctyl tin laurate (DOTL), dibutyl phthalate (DBP), dilauryl phthalate (DLP), butyl benzyl phthalate (BBP), diisodecyl phthalate (DIDP), diisononyl phthalate (DINP), dimethyl phthalate, and diethyl phthalate.

An example of the aliphatic plasticizer includes an adipate such as dioctyl adipate (DOA), diisononyl adipate (DINA), diisodecyl adipate, adipic acid propylene glycol polyester, and adipic acid butylene glycol polyester.

Examples of the plasticizer include higher alcohols (for example, lauryl alcohol, stearyl alcohol, and the like); drying oils and oils extracted from animals and plants (for example, paraffins (paraffin-based oil and the like)), waxes, naphthene, aroma, asphalts, linseed oils, and the like); petroleum-based oils; low molecular weight polymers; and organic acid esters (for example, phosphoric ester, higher aliphatic acid ester, alkyl sulfonic acid ester, and the like).

The plasticizers can be used alone or in combination of two or more. As the plasticizer, preferably, an aliphatic plasticizer is used, or more preferably, an adipate is used.

The plasticizer is blended at a mixing ratio of, for example, 10 to 300 parts by mass, or preferably 15 to 200 parts by mass with respect to 100 parts by mass of the carboxyl group-containing polymer.

When the mixing ratio of the plasticizer is below 10 parts by mass with respect to 100 parts by mass of the carboxyl group-containing polymer, the flexibility of the moisture-curable sealing composition before curing becomes insufficient, so that it may be difficult to allow the moisture-curable sealing composition to follow the shape of the gap portion. When the mixing ratio of the plasticizer exceeds 300 parts by mass with respect to 100 parts by mass of the carboxyl group-containing polymer, it may be difficult to cure the moisture-curable sealing composition.

An example of the metal oxide which is contained in the metal oxide-containing component includes an oxide of a Group 2 element (a Group 2 element of the periodic table (Revised edition of IUPAC Inorganic Chemistry Nomenclature (1989)) such as a calcium oxide, a magnesium oxide, a strontium oxide, and a barium oxide.

When the metal oxide is the oxide of the Group 2 element, a metal hydroxide can be produced by the reaction of water with the metal oxide and a cross-link can be formed by an ion bond of a metal ion in the metal hydroxide with a carboxyl group in the carboxyl group-containing polymer.

The metal oxide-containing component may be the metal oxide itself (containing 100% of the metal oxide) and can be prepared as a mixture in which a metal oxide is mixed.

Examples of the mixture of the metal oxide include a portland cement (containing, as a metal oxide, CaO, SiO₂, Al₂O₃, and Fe₂O₃) such as a white portland cement; a mixed cement such as a portland blast furnace cement (containing, as a metal oxide, CaO, SiO₂, Al₂O₃, Fe₂O₃, and MgO), a fly ash cement (containing, as a metal oxide, CaO, SiO₂, Al₂O₃, Fe₂O₃, and MgO), and a silica cement (containing, as a metal oxide, CaO, SiO₂, Al₂O₃, and Fe₂O₃); and a special cement such as an alumina cement (containing, as a metal oxide, CaO, SiO₂, Al₂O₃, Fe₂O₃, and MgO). Preferably, a portland cement is used.

The metal oxide-containing component contains, for example, 85 to 100 mass %, or preferably 90 to 99.5 mass % of the metal oxide and further contains, for example, 55 to 75 mass %, or preferably 60 to 70 mass % of the oxide of the Group 2 element.

Examples of the metal carbonate include a carbonate of a Group 2 element (a Group 2 element of the periodic table (Revised edition of IUPAC Inorganic Chemistry Nomenclature (1989)) such as a calcium carbonate, a magnesium carbonate, a strontium carbonate, and a barium carbonate; a carbonate of a Group 12 element (a Group 12 element of the periodic table (Revised edition of IUPAC Inorganic Chemistry Nomenclature (1989)) such as a zinc carbonate; and a carbonate of a transition metal such as a manganese carbonate, a ferrous carbonate, a cobaltous carbonate, a nickelous carbonate, and a cupric carbonate. Preferably, a carbonate of a Group 2 element is used, or more preferably, a calcium carbonate is used.

When the metal carbonate is the carbonate of the Group 2 element, a metal ion can be easily produced and a cross-link can be formed by an ion bond of a metal ion in the metal carbonate with a carboxyl group in the carboxyl group-containing polymer.

The metal oxide-containing component and/or the metal carbonate are/is appropriately blended in accordance with the type of the carboxyl group-containing polymer and the content of the carboxyl group. To be specific, the metal oxide-containing component and/or the metal carbonate are/is blended, as a total amount thereof, at a mixing ratio of, for example, 3 to 200 parts by mass, or preferably 10 to 180 parts by mass with respect to 100 parts by mass of the carboxyl group-containing polymer.

When the mixing ratio of the metal oxide-containing component and/or the metal carbonate is below 3 parts by mass with respect to 100 parts by mass of the carboxyl group-containing polymer, it may be difficult to cure the moisture-curable sealing composition. When the mixing ratio of the metal oxide-containing component and/or the metal carbonate exceeds 200 parts by mass with respect to 100 parts by mass of the carboxyl group-containing polymer, there may a case where the curing rate of the moisture-curable sealing composition excessively becomes faster, so that the pot life of the moisture-curable sealing composition is shortened or a case where the flexibility of the moisture-curable sealing composition before curing becomes insufficient, so that it becomes difficult to allow the moisture-curable sealing composition to follow the shape of the gap portion.

A tackifier can be blended in the moisture-curable sealing composition of the present invention as required.

Examples of the tackifier include a rosin resin, rosin esters, a terpene resin (for example, a terpene-aromatic liquid resin, a polyterpene resin, and the like), a coumarone resin, an indene resin, a coumarone-indene resin, a petroleum resin (for example, a C5/C9 petroleum resin and the like), and a phenol resin. Preferably, a coumarone resin is used.

The tackifier is blended at a mixing ratio of, for example, 200 parts by mass or less, or preferably 10 to 150 parts by mass with respect to 100 parts by mass of the carboxyl group-containing polymer.

When the tackifier is blended in the moisture-curable sealing composition, the adhesiveness of the moisture-curable sealing composition with respect to an object to be sealed can be improved.

A known additive can be appropriately blended in the moisture-curable sealing composition of the present invention as required. Examples of the known additive include fillers, pigments, antioxidants, and flame retardants.

Examples of the filler include a hollow filler such as a hollow bead, a foamable filler such as a thermally foamable bead, and an inorganic filler such as talc, other than the above-described metal carbonate. Preferably, a hollow filler and a foamable filler are used.

When the filler is the hollow filler or the foamable filler, the apparent density of the moisture-curable sealing composition can be reduced, so that the weight reduction of the moisture-curable sealing composition can be achieved.

In order to prepare the moisture-curable sealing composition of the present invention, the carboxyl group-containing polymer, the plasticizer, and the metal oxide-containing component and/or the metal carbonate, and if necessary, the tackifier and the additive are blended at the above-described mixing proportion to be mixed at, for example, 50 to 150° C. using, for example, a mixing roll, or the like.

The preparation of the moisture-curable sealing composition is performed under, for example, a dry gas so that the moisture-curable sealing composition is not in contact with moisture for a long time.

In this way, the moisture-curable sealing composition is prepared in a viscous paste state (in a putty state).

The gel fraction (a toluene-insoluble component) of the obtained moisture-curable sealing composition is, for example, 10 mass % or less, or preferably 5 mass % or less.

The tensile strength (in conformity with JIS K 6767) of the obtained moisture-curable sealing composition with an elongation of 100% is, for example, 30 N or less, or preferably 20 N or less.

The hardness of the obtained moisture-curable sealing composition before curing is, in a Type C hardness test specified in JIS K 7312, for example, 5 to 50, or preferably 5 to 30 when measured after a pressurized surface of a Type C durometer is brought into close contact therewith for 10 seconds.

The hardness of the moisture-curable sealing composition before curing can be adjusted by adjusting the mixing amount of the plasticizer and that of the metal oxide-containing component and/or the metal carbonate. When the above-described hardness is below 5, the moisture-curable sealing composition may flow out from a gap by sagging or dripping before curing. When the above-described hardness exceeds 50, the flexibility of the moisture-curable sealing composition becomes insufficient, so that it may become difficult to allow the moisture-curable sealing composition to follow the shape of the gap portion.

The moisture-curable sealing composition fills a gap portion or the like and then, absorbs the surrounding moisture, so that the moisture-curable sealing composition is cured.

To be specific, when the moisture-curable sealing composition absorbs the surrounding moisture, a metal hydroxide is produced by the reaction of water with the metal oxide. Thereafter, an ion bond is formed between a metal ion in the metal hydroxide and a carboxyl group in the carboxyl group-containing polymer. Alternatively, an ion bond is formed between a metal ion in the metal carbonate and a carboxyl group in the carboxyl group-containing polymer.

The gel fraction (a toluene-insoluble component) of the moisture-curable sealing composition after curing is, for example, 30 mass % or more, preferably 40 mass % or more, more preferably 50 mass % or more, or even more preferably 60 mass % or more.

The tensile strength (in conformity with JIS K 6767) of the moisture-curable sealing composition after curing with an elongation of 100% is, for example, 1 N or more, or preferably 5 N or more, and is usually 30 N or less.

The moisture-curable sealing composition may directly fill a gap using a spatula or the like. Alternatively, the moisture-curable sealing composition is formed into a sheet shape in advance as a sealing composition sheet and the sealing composition sheet can fill the gap.

In order to form the sealing composition sheet, the moisture-curable sealing composition is extended by applying pressure using, for example, a known pressing machine, extrusion molding machine, or the like to be formed into a sheet having a predetermined thickness. Alternatively, the moisture-curable sealing composition can be applied onto both surfaces of a substrate such as a non-woven fabric to be formed into a sealing composition sheet.

The moisture-curable sealing composition and the sealing composition sheet are sealed off so as not to be in contact with water or moisture until they are used.

According to the moisture-curable sealing composition, without adjusting the viscosity, before curing, the flexibility thereof is ensured, so that the followability with respect to a gap portion can be improved, and after curing, a sag or drip is prevented and the generation of a space in the gap portion is suppressed, so that the moisture-curable sealing composition can uniformly fill the gap portion.

### EXAMPLES

The present invention will now be described in more detail by way of Examples and Comparative Examples. However, the present invention is not limited to the following Examples and Comparative Examples.

### Example 1

A monomer composition prepared from 85 parts by mass of butyl acrylate, 2 parts by mass of acrylic acid, and 15 parts by mass of acrylonitrile was polymerized, so that a carboxyl-modified acrylic polymer A (a carboxyl group-containing polymer, the content of the carboxyl group of 1.2 mass %, a solid content of 100%) was obtained.

The acrylic polymer A, an adipate (Polycizer P-103, manufactured by DIC Corporation), and a white portland cement (a metal oxide-containing component, 66 mass % of CaO, 24 mass % of SiO₂, 4 mass % of Al₂O₃, 0.2 mass % of Fe₂O₃) were blended at a mixing proportion shown in Table 1 to be mixed at 120° C. using a mixing roll, so that a moisture-curable sealing composition was obtained.

The obtained moisture-curable sealing composition was extended by applying pressure with a pressing machine and a sealing composition sheet having a thickness of 1 mm was obtained.

### Examples 2 to 5

A moisture-curable sealing composition and a sealing composition sheet were obtained in the same manner as in Example 1, except that an acrylic polymer A, an adipate (Polycizer P-103, manufactured by DIC Corporation), a white portland cement (a metal oxide containing-component, 66 mass % of CaO, 24 mass % of SiO₂, 4 mass % of Al₂O₃, 0.2 mass % of Fe₂O₃), and a coumarone resin (a tackifier, Coumarone V-120, manufactured by NITTO CHEMICAL CO., LTD.) were blended at a mixing proportion shown in Table 1.

### Example 6

A monomer composition prepared from 85 parts by mass of butyl acrylate, 6 parts by mass of acrylic acid, and 15 parts by mass of acrylonitrile was polymerized by suspension polymerization, so that a carboxyl-modified acrylic polymer B (a carboxyl group-containing polymer, the content of the carboxyl group of 3.5 mass %, a solid content of 100%) was obtained.

A moisture-curable sealing composition and a sealing composition sheet were obtained in the same manner as in Example 1, except that the acrylic polymer B, an adipate (Polycizer P-103, manufactured by DIC Corporation), and a white portland cement (a metal oxide-containing component, 66 mass % of CaO, 24 mass % of SiO₂, 4 mass % of Al₂O₃, 0.2 mass % of Fe₂O₃) were blended at a mixing proportion shown in Table 1.

### Example 7

A monomer composition prepared from 85 parts by mass of butyl acrylate, 2 parts by mass of acrylic acid, and 15 parts by mass of acrylonitrile was polymerized, so that a carboxyl-modified acrylic polymer A (a carboxyl group-containing polymer, the content of the carboxyl group of 1.2 mass %, a solid content of 100%) was obtained.

The acrylic polymer A, an adipate (Polycizer P-103, manufactured by DIC Corporation), and a calcium carbonate were blended at a mixing proportion shown in Table 2 to be mixed at 120° C. using a mixing roll, so that a moisture-curable sealing composition was obtained.

The obtained moisture-curable sealing composition was extended by applying pressure with a pressing machine and a sealing composition sheet having a thickness of 1 mm was obtained.

### Examples 8 to 11

A moisture-curable sealing composition and a sealing composition sheet were obtained in the same manner as in Example 1, except that an acrylic polymer A, an adipate (Polycizer P-103, manufactured by DIC Corporation), a calcium carbonate, and a coumarone resin (a tackifier, Coumarone V-120, manufactured by NITTO CHEMICAL CO., LTD.) were blended at a mixing proportion shown in Table 2.

### Example 12

A monomer composition prepared from 85 parts by mass of butyl acrylate, 6 parts by mass of acrylic acid, and 15 parts by mass of acrylonitrile was polymerized by suspension polymerization, so that a carboxyl-modified acrylic polymer B (a carboxyl group-containing polymer, the content of the carboxyl group of 3.5 mass %, a solid content of 100%) was obtained.

A moisture-curable sealing composition and a sealing composition sheet were obtained in the same manner as in Example 1, except that the acrylic polymer B, an adipate (Polycizer P-103, manufactured by DIC Corporation), and a calcium carbonate were blended at a mixing proportion shown in Table 2.

### Comparative Example 1

A putty-like sealing composition and a sealing composition sheet were obtained in the same manner as in Example 1, except that an acrylic polymer A and an adipate (Polycizer P-103, manufactured by DIC Corporation) were blended at a mixing amount shown in Table 3.

### Comparative Example 2

A putty-like sealing composition and a sealing composition sheet were obtained in the same manner as in Example 1, except that an acrylic polymer A, an adipate (Polycizer P-103, manufactured by DIC Corporation), and a talc (a filler) were blended at a mixing amount shown in Table 3.

### Comparative Example 3

As shown in Table 3, a commercially available one-liquid curable silicone resin (liquid, an acetone type) was used.

Evaluation Method 1. Measurement of Gel Fraction (Toluene-Insoluble Component)

The toluene-insoluble component before curing and after curing (after curing at a temperature of 40° C. and a humidity of 90% for 12 hours, the same in the following tests) was measured using the moisture-curable sealing compositions obtained in Examples and Comparative Examples.

A moisture-curable sealing composition before curing or after curing was weighed and then, was immersed in toluene for 48 hours to be swollen and dissolved. Thereafter, the obtained product was filtrated with a wire net in 300 mesh and the toluene-insoluble component captured in the wire net was dried to be then weighed. Then, the percentage of the dry mass of the toluene-insoluble component with respect to the mass of the moisture-curable sealing composition before curing or after curing was calculated. The results are shown in Tables 1 to 3.

2. Hardness Test

A Type C hardness test was conducted in conformity with JIS K 7312 using the moisture-curable sealing compositions (before curing) obtained in Examples and Comparative Examples and the hardness of the moisture-curable sealing compositions (before curing) was measured after a pressurized surface of a Type C durometer was brought into close contact therewith for 10 seconds. The results are shown in Tables 1 to 3.

3. Tensile Strength Test

The tensile strength was measured in conformity with JIS K 6767. To be specific, the sealing composition sheets before curing or after curing in Examples and Comparative Examples were punched out using a dumbbell No.1 to obtain measurement samples. The measurement sample was pulled at a tensile rate of 500 mm/min using a tensile testing machine and a load (a tensile strength of 100%) at the time when the elongation of the measurement sample reached 100% was measured. The results are shown in Tables 1 to 3.

4. Odor Test

A sensory test of odor generated when the moisture-curable sealing compositions in Examples and Comparative Examples were cured and detected by the olfactory sense of a tester was conducted. The results are shown in Tables 1 to 3.

TABLE 1

| | | Examples | | | | | |
|---|---|---|---|---|---|---|---|
| Composition | | 1 | 2 | 3 | 4 | 5 | 6 |
| Acrylic Polymer | A | 100 | 100 | 100 | 100 | 100 | — |
| (Parts by Mass) | B | — | — | — | — | — | 100 |
| Adipate (Parts by Mass) | | 75 | 75 | 75 | 75 | 200 | 50 |
| Coumarone Resin (Parts by Mass) | | — | 75 | 50 | 50 | 50 | 50 |
| White Portland Cement | | 50 | 50 | 5 | 150 | 50 | 50 |
| (Parts by Mass) | | | | | | | |
| Gel Fraction | Before Curing | 0 | 0 | 0 | 0 | 0 | 0 |
| (Mass %) | After Curing | 80 | 76 | 72 | 85 | 65 | 80 |
| Hardness Test | | 20 | 25 | 25 | 25 | 10 | 30 |
| Tensile Strength | Before Curing | 5 | 7 | 7 | 8 | 5 | 9 |
| of 100% (N) | After Curing | 9 | 12 | 12 | 15 | 7 | 20 |

| | | | | | | |
|---|---|---|---|---|---|---|
| Odor | Absence | Absence | Absence | Absence | Absence | Absence |

TABLE 2

| | | Examples | | | | | |
|---|---|---|---|---|---|---|---|
| Composition | | 7 | 8 | 9 | 10 | 11 | 12 |
| Acrylic Polymer | A | 100 | 100 | 100 | 100 | 100 | — |
| (Parts by Mass) | B | — | — | — | — | — | 100 |
| Adipate (Parts by Mass) | | 75 | 75 | 75 | 75 | 200 | 50 |
| Coumarone Resin (Parts by Mass) | | — | 75 | 50 | 50 | 50 | 50 |
| Calcium Carbonate (Parts by Mass) | | 50 | 50 | 5 | 150 | 50 | 50 |
| Gel Fraction | Before Curing | 0 | 0 | 0 | 0 | 0 | 0 |
| (Mass %) | After Curing | 60 | 55 | 48 | 75 | 45 | 60 |
| Hardness Test | | 20 | 25 | 25 | 25 | 10 | 30 |
| Tensile Strength | Before Curing | 5 | 7 | 7 | 8 | 5 | 9 |
| of 100% (N) | After Curing | 9 | 12 | 11 | 18 | 7 | 18 |

| | | | | | | |
|---|---|---|---|---|---|---|
| Odor | Absence | Absence | Absence | Absence | Absence | Absence |

TABLE 3

| | | Comparative Examples | | |
|---|---|---|---|---|
| Composition | | 1 | 2 | 3 |
| Acrylic Polymer A (Parts by Mass) | | 100 | 100 | — |
| Adipate (Parts by Mass) | | 75 | 75 | — |
| Talc (Parts by Mass) | | — | 50 | — |
| One-Liquid Curable Silicone Resin | | — | — | 100 |
| (Parts by Mass) | | | | |
| Gel Fraction (Mass %) | Before Curing | 0 | 0 | 0 |
| | After Curing | 0 | 0 | 100 |
| Hardness Test | | 20 | 20 | — |
| Tensile Strength of | Before Curing | 5 | 5 | — |
| 100% (N) | After Curing | 5 | 5 | — |

| | | | |
|---|---|---|---|
| Odor | Absence | Absence | Acetone |
| | | | Odor |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The moisture-curable sealing composition and the sealing composition sheet of the present invention are used to fill a gap portion or the like.

1. A moisture-curable sealing composition comprising:
a carboxyl group-containing polymer having a carboxyl group,
a plasticizer, and
a metal oxide-containing component containing a metal oxide and/or a metal carbonate.

2. The moisture-curable sealing composition according to claim 1, wherein
the hardness thereof before curing is, in a Type C hardness test specified in JIS K 7312, 5 to 50 when measured after a pressurized surface of a Type C durometer is brought into close contact therewith for 10 seconds.

3. The moisture-curable sealing composition according to claim 1, wherein
the carboxyl group is contained in the carboxyl group-containing polymer at a content ratio of 0.1 to 10 mass %.

4. The moisture-curable sealing composition according to claim 1, wherein
the carboxyl group-containing polymer is obtained by polymerizing a monomer composition containing
55 to 95 mass % of an alkyl(meth)acrylate monomer,
4 to 40 mass % of a cyano group-containing vinyl monomer, and
0.1 to 10 mass % of a carboxyl group-containing vinyl monomer.

5. The moisture-curable sealing composition according to claim 1, wherein
the moisture-curable sealing composition further contains a tackifier.

6. The moisture-curable sealing composition according to claim 1, wherein
the plasticizer is contained at a content ratio of 10 to 300 parts by mass with respect to 100 parts by mass of the carboxyl group-containing polymer.

7. The moisture-curable sealing composition according to claim 1, wherein
the metal oxide-containing component and/or the metal carbonate are/is contained at a content ratio of 5 to 200 parts by mass with respect to 100 parts by mass of the carboxyl group-containing polymer.

8. The moisture-curable sealing composition according to claim 1, wherein
the metal oxide is an oxide of a Group 2 element.

9. The moisture-curable sealing composition according to claim 1, wherein
the metal carbonate is a calcium carbonate.

10. A sealing composition sheet formed from the moisture-curable sealing composition according to claim 1 into a sheet shape.
